(19) United States
(12) Patent Application Publication
(10) Pub. No.: US 2019/0388839 A1
(43) Pub. Date: Dec. 26, 2019

(54) SPIRAL WOUND MEMBRANE ROLLS AND MODULES

(71) Applicants: AQUAPORIN ASIA PTE. LTD., Singapore (SG); AQUAPORIN A/S, Kgs. Lyngby (DK)

(72) Inventors: Guofei SUN, Singapore (SG); Zhao YANG, Singapore (SG)

(21) Appl. No.: 16/488,322

(22) PCT Filed: Feb. 22, 2018
(86) PCT No.: PCT/EP2018/054374

§ 371 Date: Aug. 23, 2019

(30) Foreign Application Priority Data
Feb. 24, 2017 (SG) 10201701498U

(51) Int. Cl. B01D 61/00; B01D 63/10

(52) U.S. Cl. CPC B01D 61/002; B01D 65/003; B01D 63/103

(57) ABSTRACT

Spiral wound membrane rolls and modules and methods for making such membrane rolls and modules are described, along with water extraction or water filtrations systems including the spiral wound membrane rolls and modules and the use thereof in a forward osmosis process, an assisted forward osmosis process or a pressure retarded osmosis process

### FIELD

The aspects of the disclosed embodiments relate to a spiral wound membrane roll, and a membrane module comprising the spiral wound membrane roll. The membrane roll and membrane module are useful in direct osmosis driven water extraction or filtration systems in which two aqueous streams separated by a membrane and having different osmotic pressure potential create a water flux across the membrane along the pressure gradient. In addition, the aspects of the disclosed embodiments relate to water filtration systems comprising the membrane roll or membrane module.

### BACKGROUND

There are a number of challenges that impede industrial applications of forward osmosis (FO). One of the major challenges to overcome is a suitable module design that fulfils the requirements for membrane pocket area, size, effectiveness, durability, convenience and anti-fouling properties—many of these influenced by the flow paths of the two aqueous streams on each side of the membrane.

Typical examples of spiral wound FO designs of prior art (e.g. U.S. Pat. No. 4,033,878 and WO 2003/053348) disclose the flow of one of the two aqueous streams from a central perforated tube in and out of the membrane pocket from the same edge—forming a U-path. Typically, one or more glue lines in the pocket guides the aqueous stream inside the pocket. However, such glue lines occupy membrane area thereby reducing the area that is available for water flow across the membrane.

### SUMMARY

Broadly, the aspects of the disclosed embodiments provides a membrane roll comprising one or more quadrilateral membrane pockets with four edges being adapted for a first aqueous liquid flow inside the membrane pocket from one lateral edge to the other lateral edge, and a second aqueous liquid flow outside of the membrane pocket from the edge nearest the center tube to the opposite outer edge or, optionally, in the opposite direction. Thus, a crossflow is achieved where the two aqueous liquids flow at right angles to each other separated by the membrane, the membrane being a semipermeable or selectively permeable membrane. This crossflow provides an even flux over the entire membrane area and thus also provides a membrane module having a high effective membrane area to volume ratio of the finished membrane module.

The spiral membrane module of the aspects of the disclosed embodiments may be of particular advantage in effecting concentrating procedures. For example, orange juice or other fruit juices may be dewatered and concentrated by utilizing the present module in a water extraction system such as is described in US 2016/016127 “Systems for Water Extraction”. In addition, the membrane module may be utilized to advantage in a dialysis type of operation, for example, in the separation of solutes and colloids from an aqueous liquid containing dissolved impurities. In another example, a dialysis membrane may be used in a module for purifying a blood stream, where the nitrogenous waste products and other toxins will be removed by osmotic flow into a suitable artificial plasma stream, or other desired stream, flowing on the other side of the membrane. Furthermore, the membrane module may be utilized in desalting of brackish water or sea water.

Accordingly, in one aspect, the aspects of the disclosed embodiments provide a membrane roll (2) comprising:
one or more membrane pockets (3) formed by a semipermeable or selectively permeable membrane material;
   wherein each membrane pocket has four substantially straight edges:
      a center edge (4a) and a substantially opposite outer edge (4b); and
      a first lateral edge (4c) and a substantially opposite second lateral edge (4d);
   the membrane pocket(s) defining an interior region of the membrane roll (5) inside the pocket(s) and an exterior region of the membrane roll (6) outside the pocket(s);
   wherein the side of the membrane material facing the interior region is closed along the center edge (4a) and along the outer edge (4b) to prevent fluid communication with the exterior region of the membrane roll (6);
   wherein the sides of the membrane material facing the exterior region of the membrane roll (6) are sealed against the adjacent (when spiral wound) side of membrane material facing the exterior region (6) and along the first lateral edge (4c) and along the second lateral edge (4d) to prevent fluid communication with the interior region of the membrane roll (5);
   and wherein the membrane pocket(s) is/are spiral wound from the center edge (4a) to the outer edge (4b); one or more spacer elements (14) in the interior region of the membrane roll (5);
   one or more spacer elements (15) in the exterior region of the membrane roll (6); and
   a center tube (7), the center tube having means (17c) allowing fluid communication with the exterior region of the membrane roll (6); thereby creating flow paths for a first aqueous liquid to flow inside the membrane pocket(s) from one lateral edge (4c, 4d) to the other lateral edge (4c, 4d), and a second aqueous liquid to flow outside of the membrane pocket from the center edge nearest the center tube (7) to the opposite outer edge.

In situations in which the membrane modules of the aspects of the disclosed embodiments are for use in forward osmosis water extraction, the first aqueous liquid and the second aqueous liquid will genrally have different osmolarities.

In the membrane roll of the the selectively permeable membrane may have a selective layer on one side, and the selective layer may face the exterior region of the membrane pocket.

In a further aspect, the aspects of the disclosed embodiments provides a spiral wound membrane module comprising:
a membrane roll (2) as described above;
a housing body (1) having
means (1a, 1b, 1c) for defining the housing chamber space (13);
means for inlet (8) of a second aqueous liquid, the means being in fluid communication with the center tube (7);
means for outlet (9) of a second aqueous liquid, the means being in fluid communication with the housing chamber space (13);
means for inlet (10) and outlet (11) of a first aqueous liquid, the means being in fluid communication with the interior region of the membrane roll (5);
means (12a, 12b) for preventing fluid communication between the interior region of the membrane roll (5) and the housing chamber space (13).

In a further aspect, the aspects of the disclosed embodiments provides a method for making a spiral wound membrane roll comprising:
providing a center tube (7);
providing at least one membrane pocket in the form of one folded sheet of membrane material or in the form of two sheets of membrane material, the membrane pocket further enclosing a spacer element (14);
closing the membrane pocket(s) along the center edge (4a) and along the outer edge (4b) by folding and/or sealing;
placing a spacer element (15) for the exterior region on top of each membrane pocket;
applying sealant on the top of each of the membrane pockets along the first lateral edge (4c) and along the second lateral edge (4d);
rolling the membrane pocket(s) around the center tube (7).

In a further aspect, the aspects of the disclosed embodiments provides a method for making a spiral wound membrane module comprising enclosing the spiral wound membrane roll according mentioned above in a housing body (1) having
means (1a, 1b, 1c) for defining the housing chamber space (13);
means for inlet (8) of a second aqueous liquid, the means being in fluid communication with the center tube (7);
means for outlet (9) of a second aqueous liquid, the means being in fluid communication with the housing chamber space (13);
means for inlet (10) and outlet (11) of a first aqueous liquid, the means being in fluid communication with the interior region of the membrane roll (5); and
means (12a, 12b) for preventing fluid communication between the interior region of the membrane roll (5) and the housing chamber space (13).

In a further aspect, the aspects of the disclosed embodiments provides a water extraction system comprising a membrane module as described above being useful for direct or forward osmosis.

Embodiments of the present disclosure will now be described by way of example and not limitation with reference to the accompanying examples and figures. However, various further aspects and embodiments of the present disclosure will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

### BRIEF DESCRIPTION OF THE DRAWINGS

The figures are provided for the purposes of illustration and explanation of the principles and operations of the invention. The figures are not to scale and include idealized views to facilitate description. Where possible, like numerals have been used throughout the figures and description to designate the same or similar features.

FIG. 1 shows a partially cut-away isometric view of the spiral wound module of the aspects of the disclosed embodiments.

FIG. 2 shows the center tube (7), the membrane pocket (3) and the spacer elements (14) and (15) before being rolled.

FIG. 3A shows a cross-section view of a middle portion of the membrane roll (2) inside the housing body (1a), between two sealing means (12a) and (12b).

FIG. 3B shows an end view of the membrane roll (2) inside the housing body (1a).

FIG. 4A shows an embodiment of the invention with one membrane pocket having two sides facing the exterior region of the membrane roll (6a, 6b).

FIG. 4B shows an embodiment of the invention with two membrane pockets, each having two sides facing the exterior region of the membrane roll (6a, 6b of one pocket and 6c, 6d of the other pocket).

FIG. 5 shows an embodiment of the invention with 3 membrane pockets, wherein the exterior spacer elements (15) (interior spacer not shown) extend beyond the center edge (4a) to provide a spacer layer in contact with the the center tube (7) when the membrane pockets are rolled around the center tube.

### DETAILED DESCRIPTION OF THE INVENTION

The aspects of the disclosed embodiments relate to a spiral wound membrane roll and a membrane module comprising such a spiral wound membrane roll in a housing body as described in further details below and in the pending claims.

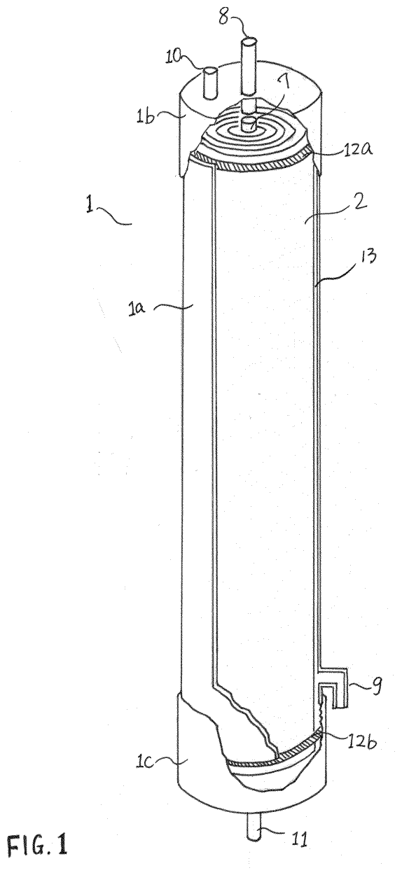

FIG. 1 shows the spiral wound membrane module according to the invention. The housing body of the spiral wound membrane module (1) comprises means for defining the housing chamber area (13). In one embodiment, the housing body comprises a housing body cylinder (1a) and two end caps (1b, 1c).

The housing body further has means for inlet of a second aqueous liquid (8), the means being in fluid communication with the center tube (7). Further, the housing body has means for outlet of a second aqueous liquid (9), the means being in fluid communication with the housing chamber space (13). The means for outlet of a second aqueous liquid may be in the form of a plurality of openings extending along the length of the center tube. In one embodiment, the means for outlet (9) is placed on the housing body cylinder (1a) at some point between the two sealing means (12a and 12b).

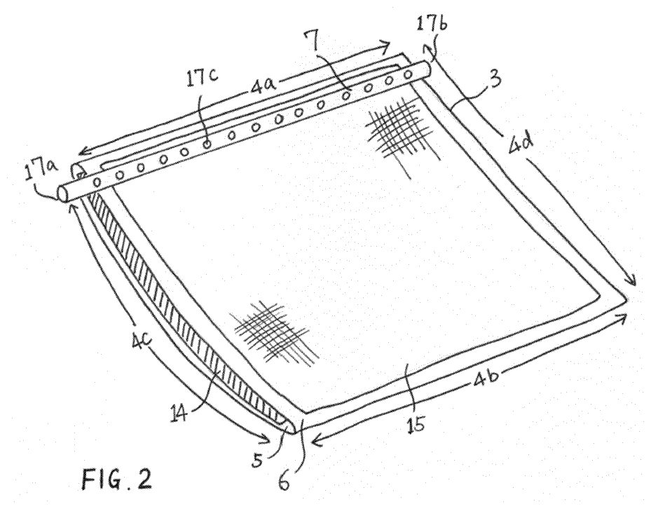

Moreover, the housing body has means for inlet (10) and means for outlet (11) of a first aqueous liquid. (10) and (11) are in fluid communication with the interior region of the membrane roll (5, FIG. 2).

The material of the housing body (1) is not particularly limited and can be made from metal or plastic or composite material. The required operating pressure ranges from about a maximum of 1 bar to about a maximum of 20 bar, depending on the type of application. The size of the housing body can generally have a diameter of 2.5-25 cm, and a length of 25-125 cm.

The spiral wound membrane roll (2) is placed in the housing body cylinder (1a). (12a) and (12b) are the two sealing means for preventing fluid communication between the interior region of the membrane roll (5, FIG. 2) and the exterior region on the surface of the membrane roll (13). In one embodiments, these means may be in the form of gaskets, e.g. made from rubber or plastic material. In another embodiment, these means may be in the form of an epoxy resin material.

The housing chamber space (13) indicated is the inner space of the housing body. Most of the housing chamber space is filled up by the membrane roll. However, space is left around the membrane roll for fluid communication between the exterior region of the membrane roll (6, FIG. 2) and the means for outlet of a second aqueous liquid (9).

FIG. 2 shows an embodiment of the invention having one membrane pocket with the center tube (7) and the membrane pocket (3) and spacer elements (14, 15) before being rolled. The center tube has an open end (17a) for inlet of a second aqueous liquid, an opposite closed end (17b) and means (17c) for fluid communication with the exterior region (6) of the membrane roll. In one embodiment, the means (17c) for communication with the exterior region (6) of the membrane roll is in the form of a number of openings, such as holes through the center tube, along the center tube (7). In another embodiment, the means (17c) for communication with the exterior region (6) of the membrane roll is in the form of one or more slits through and along the center tube. The center tube material is stiff, and it can be made from, but not limited to, metal or plastic, perforated with one or multiple openings (17c) in shapes of elliptic, oval, circle, or rectangular along the body of tube.

The membrane pocket (3) is quadrilateral having four edges: the center edge (4a) and the opposite outer edge (4b), the first lateral edge (4c) and the second lateral edge (4d). The interior region of the membrane roll (5) is indicated together with the exterior region of the membrane roll (6).

The membrane pocket is attached to the center tube (7) before rolling or winding the membrane. The center tube (7) is slightly longer than the center edge of the membrane pocket (4a), while the means (17c) for fluid communication with the exterior region (6) is aligned with the center edge (4a), without exceeding the center edge (4a).

The spacer elements in relation to the membrane pocket (3) are: (14) being the spacer element positioned in the interior region of the membrane roll (i.e. inside the membrane pocket) and (15) is the spacer element positioned in the exterior of the membrane roll (i.e. outside the membrane pocket).

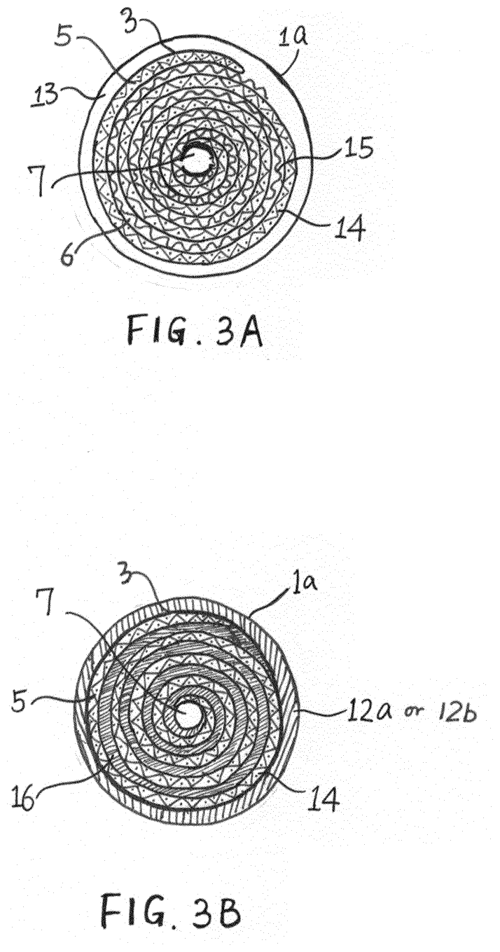

FIG. 3A shows for simplicity a cross-section view of a membrane module having one membrane roll (2) in housing body (1a) between two sealing means (12a) and (12b). In the embodiment depicted, the spiral wound roll holds one rolled membrane pocket with a spacer element (14) at the interior region of the membrane roll (5) and another spacer element (15) at the exterior region of the membrane roll (6). The interior region of the membrane roll (5) is in fluid contact with the means for inlet and outlet of the first aqueous liquid (10 and 11; FIG. 1). The exterior region of the membrane roll is in fluid contact with the center tube (7) for the second aqueous liquid.

FIG. 3B shows for simplicity an end view of a membrane module having one membrane roll (2) in the housing body (1a) as it appears at either end of the housing body. The sealing means (12a or 12b) fills up the gap between the membrane roll (3) and the housing body (1a) to prevent fluid communication between the interior region of the membrane roll (5) and the housing chamber area (13, FIG. 1). (16) is the sealed part of the exterior region of the membrane roll (6), along the first lateral edge (4c, FIG. 2) or the second lateral edge (4d, FIG. 2). The sealing of membrane material is described in further detail below. In the center of the membrane roll is seen the center tube (7). There is similar sealing means on the two ends of the membrane roll.

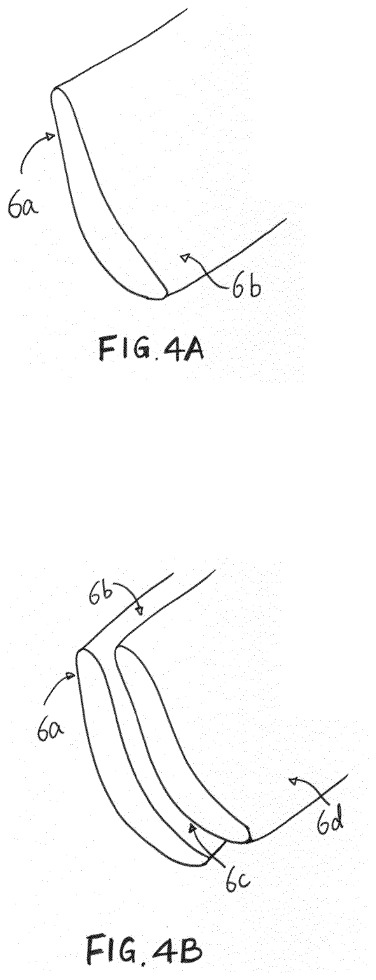

FIGS. 4A and 4B relate to the sealing of the sides of the membrane material facing the exterior region of the membrane roll (6). These sides are sealed against the adjacent (when spiral wound) side of membrane material facing the exterior region (6) and along the first side edge (4c) and along the second side edge (4d) to prevent fluid communication with the interior region of the membrane roll (5).

In one embodiment, this sealing process relates to only one membrane pocket. FIG. 4A specifically shows an embodiment of the invention with one membrane pocket having two sides facing the exterior region of the membrane roll (6a, 6b). For this embodiment, these two sides (6a) and (6b) are sealed against each other along the exterior part of the lateral edge where adhesive lines (18) are shown.

In further embodiments, the membrane roll comprises two or more membrane pockets. FIG. 4B shows such an embodiment of the invention with two membrane pockets, each having two sides facing the exterior region of the membrane roll (6a, 6b of one pocket and 6c, 6d of the other pocket). In this embodiment, one side of the first membrane pocket (6a) is sealed against the adjacent (when spiral wound) side of the other membrane pocket (6d); and the other side of the first membrane pocket (6b) is sealed against the adjacent (when spiral wound) side of the other membrane pocket (6c) along the exterior part of the lateral edge where adhesive lines (18) are shown.

Production of the Spiral Wound Module

For illustration, the following is one example of production of a membrane roll and a membrane module having one membrane pocket according to the invention:
1. A membrane sheet is half-folded with a layer of spacer element for the interior region (14) in the middle. The edge opposite to the folded edge is sealed by a suitable adhesive to form the membrane pocket (3). The center edge (4a) can either be the folded edge or the sealed edge.
2. The spacer element (15) for the exterior region is placed on top of the membrane pocket (3). Two adhesive lines (18) are applied onto the top of the membrane pocket (6b) (penetrating the spacer element) along the first lateral edge (4c) and the second lateral edge (4d). The center tube (7) is placed on the spacer (15) on top of the membrane pocket close to the center edge (4a). The membrane pocket is then rolled around the center tube. When the membrane pocket is rolled up around the center tube, both the center tube and the spacer element are fixed on to the membrane pocket by the adhesive lines. Upon the rolling, the back side (6a) of the membrane pocket will be sealed along the adhesive lines (18) to the top side of the membrane pocket (6b), such as to form a spiral wound membrane roll (2).
3. The membrane roll (2) is inserted into the housing body cylinder (1a) and two sealing means (12a and 12b) are installed prior to or during fastening the end caps (1b and 1c) to the housing body cylinder (1a). For example, if the sealing means (12a and 12b) are two rubber gaskets that are pre-installed in the end caps (1b and 1c), the gaskets can be compressed and thereby sealing the gap between the membrane roll and housing body cylinder, while the caps are fastened to the housing body.
4. The end cap (1b) is designed in a way that the inlet of the second aqueous liquid (8) is tightly connected to the center tube (7) when it is installed to the housing body.

For production of a membrane roll and a membrane module with more than one membrane pocket, step 2 above will be modified as follows:
2a. The spacer element (15) for the exterior region is placed on top of the membrane pocket to form a membrane set.
2b. Two adhesive lines (18) are applied onto the top of the first membrane set penetrating the spacer element (15) along the first lateral edge (4c) and the second lateral edge (4d). 2c. The second membrane set is placed on top of the first membrane set with the two lateral edges (4c and 4d) aligned with the first membrane set, but the center edge (4a) of the second membrane pocket is slightly shifted towards the opposite outer edge (4b). The second membrane set is attached to the first membrane set by the two adhesive lines applied in the above mentioned step.
2d. Step 2b and 2c are repeated when more membrane pockets are installed. Afterwards, two adhesive lines are applied on to the top side of the stacked membrane sets following the same procedures as in step 2b.
2e. The center tube (7) is placed on the top-most membrane pocket close to the center edge (4a). When the stacked membrane sets are rolled up to the center tube, the exterior spacer elements (15) in all the membrane sets are in touch with the center tube body in order to achieve even flow distribution of the second aqueous liquid to the exterior region of the membrane roll (6). The center tube and the top-most spacer element are fixed on to the top-most membrane pocket by the adhesive lines. Upon the rolling, the back side of the first membrane set will be sealed to the top side of the top-most membrane set, such as to form a spiral wound membrane roll (2).

Optionally, when assembling the membrane set(s) in step 2, or 2a above, the spacer element (15) may be allowed to extend slightly beyond the center edge (4a) to provide a spacer layer in contact with the means for outlet of the second aqueous liquid (9), see FIG. 5. The spacer element may e.g. extend beyond the center edge by a distance of between about P and about P/n, wherein P is the perimeter of the center tube and n is the number of membrane sets in the spiral wound membrane roll. This will ease fluid communication from the center tube (7) into the exterior region of the membrane roll (6).

The spiral wound membrane module may include a plurality of membrane sets or pockets. While one membrane set is shown (FIGS. 1 and 2), preferred embodiments include at least 2 membrane sets, at least 3 membrane sets, at least 4 membrane sets, at least 5 membrane sets, at least 6 membrane sets, and in some embodiments at least 10, at least 20 or even 50. Materials for constructing various components of spiral wound modules are well known in the art.

The Membrane Material

In one embodiment, the membrane material for forming the membrane pocket(s) comprises an active or selective layer and a support layer. In a further embodiment, the selective layer is a semipermeable membrane or a selectively permeable membrane. In a further embodiment, the selective layer comprises nanoporous water channels.

In a further embodiment, the nanoporous water channels are selected from the group consisting of nanoparticles, nanotubes, carbon nanotubes, graphene based materials, aquaporin water channels and biomimetic synthetic water selective porous material.

In a further embodiment, the selective layer is a thin film or thin film composite (TFC) membrane, such as is formed by interfacial polymerization. Furthermore, the selective layer may be formed by successive deposition on the support of polyelectrolyte layers having alternating charges, i.e. the layer-by-layer technology.

In a further embodiment, the selectivity of the selective layer may be further enhanced by comprising aquaporin water channels, such as in a layer wherein the aquaporin water channels are immobilized, such as more or less embedded or partly embedded in or even supported in or on the selective layer. The selective layer is preferably created in close contact with a support layer, such as a typical polysulfone or polyether sulfone support membrane. In a further embodiment, the selective or active layer comprising immobilized aquaporin water channels is a cross linked aromatic amide thin film.

In a further embodiment the support layer is a porous polysulfone or polyether sulfone support membrane.

In a still further embodiment, the membrane material is a cellulose triacetate (CTA) membrane.

“Aquaporin water channel” as used herein refers to selective water channel proteins, including AqpZ and SoPIP2;1, e.g. prepared according to the methods described by Maria Karlsson et al. (FEBS Letters 537 (2003) 68-72) or as described in Jensen et al. US 2012/0080377 A1.

“Thin-film” and Thin-film-composite” or (TFC) membranes as used herein refers to a thin film membrane selective layer, the layer being prepared using an amine reactant, preferably an aromatic amine, such as a diamine or triamine, e.g. 1,3-diaminobenzene (m-phenylenediamine) in an aqueous liquid, and an acyl halide reactant, such as a di- or triacid chloride, preferably an aromatic acyl halide, e.g. benzenee-1,3,5-tricarbonyl chloride (trimesoyl chloride (TMC)) dissolved in an organic solvent where the reactants combine in an interfacial polymerization reaction, and wherein a hydrophilic composite material, such as zeolite nanoparticles, or immobilized and/or stabilised aquaporin water channels are included U.S. Pat. No. 4,277,344 which dscribes in detail the formation of a polyamide thin film formed at the surface of a porous membrane support, e.g. a polyethersulfone membrane.

The “support layer” or support substrate functioning as membrane support may be e.g. a polyethersulfone membrane, such as the porous PES support membrane, e.g. a MICROPES 1FPH or 2FPH membrane from Membrana GmbH, or the support layer may be further reinforced by being cast on a woven or non-woven sheet, such as a thin polyester material. Other examples of support layers may include, but are not limited to, a cellulose acetate substrate, a nitrocellulose substrate, a cellulose esters substrate, a polycarbonate substrate, a polyamine substrate, a polyimide substrate, a polysulfone substrate, a polyether sulfone substrate, a polyacrilonitrile substrate, a polyethylene substrate, a polypropylene substrate, a polytetrafluoroethylene substrate, a polyvinylidene fluoride substrate, a polyvinylchloride substrate, a polyterepthalate substrate, an alumina oxide substrate, a titania oxide substrate, a zirconia oxide substrate, a perovskite-type oxides substrate and mixtures thereof.

Spacer Elements

The “spacer element” as used herein may be used to create a distance and thus space between adjacent membrane material, either between membrane material of the same membrane pocket or between membrane material of two adjacent pockets.

Spacer elements may be selected to create flow paths, such as flow channels, along one or either side of the membrane material.

The spacer element may be in the form of a mesh structure, such as a mesh sheet; or it may be an element attached to or integrated with the membrane material. Different designs may be selected for spacer elements (14) in the interior region of the membrane roll and for the spacer elements (15) in the exterior region of the membrane roll, depending i.a. on which is the draw and feed sides, cf. US2003205520.

Materials commonly used for spacers include polyethylene, polyester, tricot polyester and polypropylene mesh materials.

Center Tube

The center tube may typically be made from plastic materials such as acrylonitrile-butadiene-styrene, polyvinyl chloride, polysulfone, poly (phenylene oxide), polystyrene, polypropylene, polyethylene or the like.

Sealing of Membrane Material

The membrane material may be sealed in any suitable manner, such as with adhesives (including urethanes, silicones, acrylates, hot melt adhesives and UV curable adhesives and curable epoxy adhesives), heat welding, ultrasonic welding, wiring, taping, application of gasket and the like, or any combination thereof, for example, depending on the particular material forming the components. The adhesive used for sealing the edges of the membrane pockets preferably permits relative movement of the various sheet materials during the winding process. That is, the cure rate or period of time before which the adhesive becomes tacky is preferably longer than that required to assemble and wind the membrane sets about the center tube.

Using the Spiral Wound Membrane Module in a Forward Osmosis Process

The spiral wound membrane module of the invention may be used in a forward osmosis (FO) process, in an assisted forward osmosis (AFO) process such as a pressure assisted forward osmosis process (PAFO), in a pressure retarded osmosis (PRO) process. In the majority of these processes an osmotic pressure gradient applied across a semi-permeable or selectively permeable membrane results in extraction of water from an aqueous liquid. The driving force for inducing a net flow of water through the membrane is an osmotic pressure gradient from a draw aqueous liquid of higher osmotic pressure relative to that of the feed aqueous liquid (in the case of FO), optionally assisted by a slight pressure (in the case of AFO/PAFO).

Thus, in a further aspect, the aspects of the disclosed embodiments relate to a water extraction system comprising a forward osmosis membrane module according to the present disclosure.

In a further aspect, the water extraction system is for use in a forward osmosis (FO) process.

In a further aspect, the water extraction system is for use in an assisted forward osmosis (AFO) process. The term “assisted forward osmosis” (AFO) (or “pressure assisted forward osmosis”, PAFO) as used herein refers to the concept of applying a mechanical pressure to the feed side of the membrane to enhance the water flux through synergizing the osmotic and hydraulic driving forces.

In a further aspect, the water extraction system is for use in a pressure retarded forward osmosis (PRO) process. The term “pressure retarded osmosis” (PRO) as used herein refers to the concept of utilizing the built-up pressure on the draw side of the membrane as a power source (salinity power or osmotic power), cf. WO2007/033675.

In the osmotic process according to the invention, one side of the membrane, e.g. the side of the membrane which is the inside of the pocket, faces one of the draw aqueous liquid or the feed aqueous liquid whereas the other side of the membrane, e.g. the side of the membrane which is outside the pocket faces the other one of the draw aqueous liquid or the feed aqueous liquid.

Thus, in one embodiment of the forward osmosis membrane module of the invention, the first aqueous liquid is a draw aqueous liquid and the second aqueous liquid is a feed aqueous liquid.

In a further embodiment, the first aqueous liquid is a feed aqueous liquid and the second aqueous liquid is a draw aqueous liquid.

“Osmotic pressure” is the pressure that must be applied to prevent the net flow of solvent through a semipermeable membrane from an aqueous liquid of lower solute concentration to a aqueous liquid of higher solute concentration. The osmotic pressure of an aqueous liquid depends on the amount of particles in the aqueous liquid. Ideally, the osmotic pressure is directly proportional to the molality.

“Feed aqueous liquid” means an aqueous liquid of solutes in water.

“Draw aqueous liquid” means an aqueous liquid of higher osmotic pressure, relative to that of the feed aqueous liquid. The draw aqueous liquid may comprise a draw solute selected from at least one of: water-soluble inorganic chemicals and water-soluble organic chemicals.

Membrane Orientation

In forward osmosis processes the membrane orientation may be of importance. Thus, in one embodiment of the forward osmosis membrane module of the invention, the selective layer faces the feed aqueous liquid. This orientation is also called the FO mode. In a further embodiment of the module, the selective layer faces the draw aqueous liquid. This orientation is also called the PRO mode.

Thus, in one embodiment, the selective layer of the membrane material faces the first aqueous liquid; i.e. the exterior region of the membrane roll.

In a further embodiment, the selective layer of the membrane material faces the second aqueous liquid; i.e. the interior region of the membrane roll.

### Examples

Use of the Spiral Wound Membrane Module of the Invention Having 2 Rolls of Membrane Pockets of 4″ Diameter Corresponding to 3.5 m² Membrane Area in a Water Extraction System

A first aqueous liquid with a high osmotic pressure, such as ocean water, is passed using a peristaltic pump at a flow rate of 3 L/min through the module from the inlet (8) for the center tube (7) through the perforations (7c) onto the exterior region of the selectively permeable membrane pockets, which herein is a composite forward osmosis membrane of about 100 μm thickness comprising a cross-linked aromatic polyamide thin film created through interfacial polymerization on a polysulfone porous support cast on a non-woven polyester sheet, and a second relatively diluted aqueous liquid to be concentrated is passed using a second peristaltic pump at a flow rate of 30 L/min through the inlet (10) into the interior region of the membrane pockets thereby creating a cross flow across the membrane pocket relative to the flow of the first aqueous liquid in the exterior region of the membrane pocket resulting in extraction from outlet (11) of water from the second aqueous liquid through the membrane into the first aqueous liquid out through the outlet (9).

More specifically, a first aqueous liquid is a 3% sodium chloride solution and a second aqueous liquid is an aqueous liquid from textile dying containing a diluted textile dye composition. A test run is carried out in a batch process over about 60 minutes where a 100 L volume of diluted dye (as the second aqueous solution) was concentrated to 20 L ready for reuse in a textile dying process, obtaining a concentration factor of 5. For comparison, a standard commercially available spiral rolled FO module of 4″ diameter 40″ length and having 2 rolled membrane pockets, such as prepared as described in, e.g. U.S. Pat. No. 4,033,878 or in WO2003/053348 and operating under the same conditions, will have an active membrane area of only <3 m² resulting in a concentration factor of about <2.5. This example shows that the rolled membrane module of the invention utilises the membrane area more efficiently than was previously possible.

From the foregoing example as well as from the prior descriptive matter, it will be obvious to those familiar with direct osmosis (FO) and various reverse osmosis operations that many types of solution concentrating operations can be carried out more economically using an FO pre-treatment step. In addition, the same type of operation and same type of modules can be used to advantage to effect various dialysis types of separations.

It is not intended to limit the aspects of the disclosed embodiments to any one size of module or to any predetermined number of modules in a given separation apparatus. Nor is it intended to limit the aspects of the disclosed embodiments to the use of any one type of membrane material optionally comprising a particular incorporated or immobilised water channel materials or porous media through which the two different aqueous liquids or solutions will be flowing. Compared to the prior art of spiral wound FO membrane modules it is an advantageous feature of the present spiral rolled water membrane module to make use of the full interior and exterior membrane areas for true cross flow filtration without the need for internal tubular blocking means or built-in membrane walls or baffles.

1-32. (canceled)

33. A membrane roll comprising
one or more membrane pockets formed by a semipermeable or selectively permeable membrane material;
wherein each membrane pocket has four substantially straight edges:
a center edge and a substantially opposite outer edge; and
a first lateral edge and a substantially opposite second lateral edge;
the membrane pocket(s) defining an interior region of the membrane roll inside the pocket(s) and an exterior region of the membrane roll outside the pocket(s);
wherein the side of the membrane material facing the interior region is closed along the center edge and along the outer edge to prevent fluid communication with the exterior region of the membrane roll;
wherein the sides of the membrane material facing the exterior region of the membrane roll are sealed against the adjacent (when spiral wound) side of membrane material facing the exterior region and along the first lateral edge and along the second lateral edge to prevent fluid communication with the interior region of the membrane roll;
and wherein the membrane pocket(s) is/are spiral wound from the center edge to the outer edge; one or more spacer elements in the interior region of the membrane roll;
one or more spacer elements in the exterior region of the membrane roll; and
a center tube, the center tube having means allowing fluid communication with the exterior region of the membrane roll; thereby creating flow paths for a first aqueous liquid to flow inside the membrane pocket(s) from one lateral edge to the other lateral edge, and a second aqueous liquid to flow outside of the membrane pocket from the center edge nearest the center tube to the opposite outer edge.

34. The membrane roll according to claim 33 wherein the first aqueous liquid and the second aqueous liquid have different osmolarities.

35. The membrane roll according to claim 33, wherein the selectively permeable membrane has a selective layer on one side, the selective side facing the exterior of the membrane pocket.

36. The membrane roll according to claim 33, wherein the center tube is in fluid communication with the exterior region of the membrane roll along a substantial part of the center edge of the membrane pocket.

37. The membrane roll according to claim 33, wherein each membrane pocket is formed by folding one sheet of membrane material, the closing of the side of the membrane material facing the interior region along the center edge and along the outer edge being in the form of folding the membrane material or sealing the membrane material forming the pocket.

38. The membrane roll according to claim 33, wherein each membrane pocket is formed by combining two sheets of membrane material, the closing of the side of the membrane material facing the interior region along the center edge and along the outer edge being in the form of sealing the membrane material forming the pocket.

39. The membrane roll according to claim 33, comprising one membrane pocket having two sides facing the exterior region of the membrane roll and wherein these two sides are sealed against each other.

40. The membrane roll according to claim 33, comprising two membrane pockets having each two sides facing the exterior region of the membrane roll and wherein:
one side of the first membrane pocket is sealed against the adjacent (when spiral wound) side of the other membrane pocket; and
the other side of the first membrane pocket is sealed against the adjacent (when spiral wound) side of the other membrane pocket.

41. A spiral wound membrane module comprising:
a membrane roll according to claim 33;
a housing body having
means for defining the housing chamber space;
means for inlet of a second aqueous liquid, the inlet means being in fluid communication with the center tube;
means for outlet of a second aqueous liquid, the means being in fluid communication with the housing chamber space;
means for inlet and outlet of a first aqueous liquid, the means being in fluid communication with the interior region of the membrane roll; and
means for preventing fluid communication between the interior region of the membrane roll and the housing chamber space.

42. The module according to claim 41, wherein the exterior region of the membrane roll is in fluid communication with the housing chamber space along a substantial part of the outer edge of the membrane pocket(s).

43. The module according to claim 41, wherein the means for preventing fluid communication between the interior region of the membrane roll and the housing chamber space are in the form of barrier rings, such as rubber gaskets, at each end of the membrane roll.

44. The roll according to claim 33, wherein the membrane material comprises an active layer and a support layer, the active layer being a semipermeable membrane.

45. The roll according to claim 33, wherein the semipermeable membrane layer comprises nanoporous water channels selected among the group consisting of nanoparticles, nanotubes, carbon nanotubes, graphene-based materials, aquaporin water channels and biomimetic synthetic water selective porous material.

46. The roll according to claim 33, wherein the membrane comprises a selective layer in the form of a thin film composite (TFC) layer such as comprising immobilized aquaporin water channels or the membrane is a cellulose triacetate (CTA) membrane.

47. A water extraction system comprising a membrane module according to claim 41, for use in a forward osmosis (FO) process.

48. The water extraction system according to claim 47, wherein the first aqueous liquid is a draw aqueous liquid and the second aqueous liquid is a feed aqueous liquid.

49. The water extraction system according to claim 47, wherein the first aqueous liquid is a feed aqueous liquid and the second aqueous liquid is a draw aqueous liquid.

50. The water extraction system according to claim 47, wherein the membrane material comprises an active layer and a support layer.

51. A method for making a spiral wound membrane roll comprising:
providing a center tube;
providing at least one membrane pocket in the form of one folded sheet of membrane material or in the form of two sheets of membrane material, the membrane pocket further enclosing a spacer element;
closing the membrane pocket(s) along the center edge and along the outer edge by folding and/or sealing;
placing a spacer element for the exterior region on top of each membrane pocket;
applying sealant on the top of each of the membrane pockets along the first lateral edge and along the second lateral edge;
rolling the membrane pocket(s) around the center tube.

52. A method for making a spiral wound membrane module comprising enclosing the spiral wound membrane roll according to claim 51 in a housing body having means for defining the housing chamber space;
means for inlet of a second aqueous liquid, the means being in fluid communication with the center tube;
means for outlet of a second aqueous liquid, the means being in fluid communication with the housing chamber space;
means for inlet and outlet of a first aqueous liquid, the means being in fluid communication with the interior region of the membrane roll; and
means for preventing fluid communication between the interior region of the membrane roll and the housing chamber space.
